(19) United States
(12) Patent Application Publication
(10) Pub. No.: US 2017/0015056 A1
(43) Pub. Date: Jan. 19, 2017

(54) METHOD OF SEALING PANEL JOINT AND PANEL JOINT SEALED USING THE SAME

(71) Applicant: Hyundai Motor Company, Seoul (KR)

(72) Inventor: Kyung Bum Kang, Bucheon (KR)

(21) Appl. No.: 15/099,050

(22) Filed: Apr. 14, 2016

(30) Foreign Application Priority Data
Jul. 14, 2015 (KR) 10-2015-0099717

(51) Int. Cl. B29C 65/00; F16B 5/08

(52) U.S. Cl. CPC B29C 66/7212; F16B 5/08; B29K 2307/04

(57) ABSTRACT

A method of sealing a panel joint includes steps of: attaching a forming material made of resin and reinforced fiber to a joint as a bonded end of a plurality of panels such that the joint is surrounded with the forming material; coupling a cover back to surround the forming material, and sealing a coupled end of the cover back using a sealing tape; mutually compressing the reinforced fiber and the resin of the forming material, while the reinforced fiber is impregnated with the resin, using compressive force of the cover back generated by introducing air into a nozzle connected to the cover back; and hardening the resin and removing the cover back and the sealing tape.

### CROSS REFERENCE TO RELATED APPLICATION

The present application claims under 35 U.S.C. §119(a) the benefit of Korean Patent Application No. 10-2015-0099717 filed on Jul. 14, 2015, the entire contents of which are incorporated by reference herein.

### BACKGROUND

1. Field of the Invention

The present invention relates to a method of sealing each of a plurality of panel joints by a composite material such as reinforced fiber, which is densely impregnated with resin, in a vacuum compression manner using compressive force, for securely bonding panels.

2. Description of the Related Art

In conventional vehicles, water may leak due to clearances between panels caused by joints between the panels that are not completely bonded to each other.

In the related art, this problem is resolved by welding and fastening the joints of the panels and preventing the welded portions from being deformed.

However, when the panels are bonded by welding, there are problems such as water leakage that is not resolved due to poor welding, and torsion that may be caused by the lack of stiffness of opening portions.

The foregoing is intended merely to aid in the understanding of the background of the present invention, and is not intended to mean that the present invention falls within the purview of the related art that is already known to those skilled in the art.

### SUMMARY

Accordingly, the present invention proposes a method of sealing each of a plurality of panel joints by a composite material such as reinforced fiber, which is densely impregnated with resin, in a vacuum compression manner using compressive force, for securely bonding panels.

In accordance with one aspect of the present invention, a method of sealing a panel joint includes the steps of: attaching a forming material made of resin and reinforced fiber to a joint as a bonded end of a plurality of panels such that the joint is surrounded with the forming material; coupling a cover back to surround the forming material, and sealing a coupled end of the cover back using a sealing tape; mutually compressing the reinforced fiber and the resin of the forming material, while the reinforced fiber is impregnated with the resin, using compressive force of the cover back generated by introducing air into a nozzle connected to the cover back; and hardening the resin and removing the cover back and the sealing tape.

The step of mutually compressing the reinforced fiber and the resin of the forming material may be performed at high temperature in a state in which the forming material is inserted into an oven.

The reinforced fiber may be a woven fabric including carbon fiber.

The method may further include a step of: providing an engraving having a protruding shape around the panel joint, which is performed before the step of attaching the forming material made of the resin and the reinforced fiber to the joint, and in the step of attaching the forming material made of the resin and the reinforced fiber to the joint, the forming material may be attached to the joint so as to surround the joint at a portion inside the engraving.

In accordance with another aspect of the present invention, a panel joint is sealed by attaching a forming material made of resin and reinforced fiber to the joint as a bonded end of a plurality of panels such that the joint is surrounded with the forming material, coupling a cover back to surround the forming material, and sealing a coupled end of the cover back using a sealing tape, mutually compressing the reinforced fiber and the resin of the forming material, while the reinforced fiber is impregnated with the resin, using compressive force of the cover back generated by introducing air into a nozzle connected to the cover back, and hardening the resin and removing the cover back and the sealing tape.

The panel joint may be attached so as to be surrounded with the reinforced fiber, and the resin may fill the reinforced fiber and be hardened, thereby allowing a clearance between the panels to be sealed.

The reinforced fiber may be a woven fabric including carbon fiber.

Further, a panel joint may include: a forming material made of resin and reinforced fiber attached to a joint as a bonded end of a plurality of panels such that the joint is surrounded with the forming material; and a cover back coupled to the forming material so as to surround the forming material, a coupled end of the cover back being sealed using a sealing tape, the cover back and the sealing tape configured to be removed after the resin is hardened, wherein the reinforced fiber and the resin of the forming material are mutually compressed, while the reinforced fiber is impregnated with the resin, using compressive force of the cover back generated by introducing air into a nozzle connected to the cover back.

As apparent from the above description, in accordance with the method of sealing a panel joint, since the joint is sealed in a vacuum compression manner, resin is more densely inserted into reinforced fiber. Therefore, it is possible to improve watertightness by increasing the sealing between the panels.

In addition, since the joint is compressed in a uniform direction using the contact area with the cover back, the joint can be sealed while having a smooth surface.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a schematic view illustrating a sealed state of a panel joint according to an embodiment of present invention; and

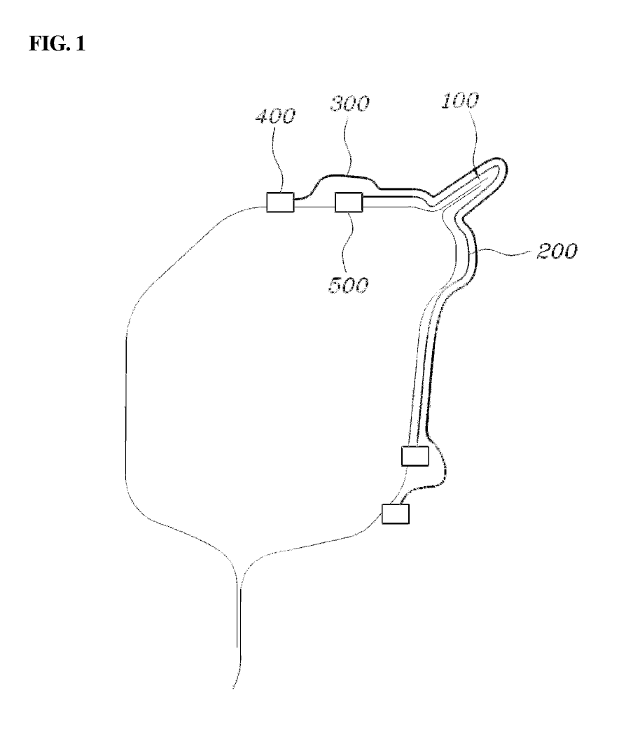

FIG. 2 is a perspective view illustrating the panel joint of FIG. 1.

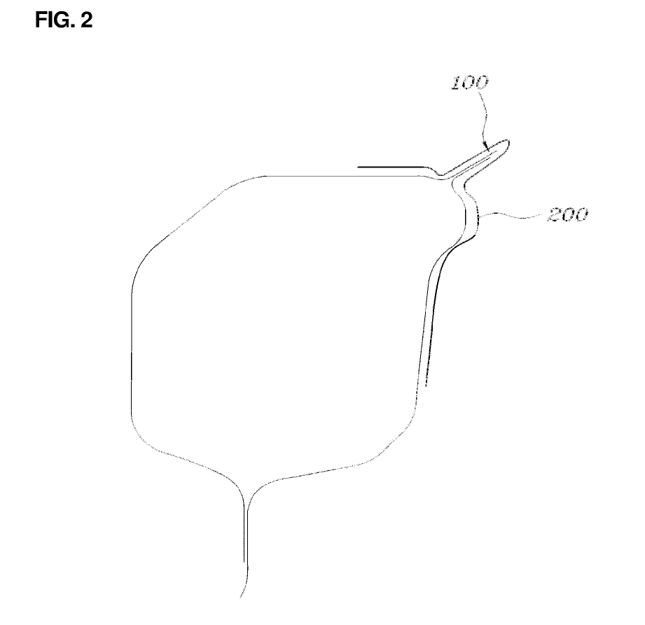

### DESCRIPTION OF PREFERRED EMBODIMENTS

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present invention may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

The preferred embodiments of the present invention will be described below with reference to the accompanying drawings.

A method of sealing a panel joint according to an embodiment of the present invention includes an attachment step of attaching a forming material 200 made of resin and reinforced fiber to a joint 100 as the bonded end of a plurality of panels such that the joint 100 is surrounded with the forming material 200, a sealing step of coupling a cover back 300 to surround the forming material 200, and of sealing the coupled end of the cover back 300 using a sealing tape 400, a forming step of mutually compressing the reinforced fiber and the resin of the forming material, while the reinforced fiber is impregnated with the resin, using the compressive force of the cover back 300 generated by introducing air into a nozzle connected to the cover back 300, and a removal step of hardening the resin and removing the cover back 300 and the sealing tape 400.

In the step of attaching the forming material 200 such that the joint 100 is surrounded with the forming material 200, the forming material 200 made of reinforced fiber and resin is arranged around the joint 100 in order to securely seal any clearance between the panels.

Through such a structure, it is possible to prevent water from being introduced by surrounding the clearance between the panels, and to resolve water leakage caused when parts between the panels are not matched with each other.

In the embodiment, the forming material 200 may be a material in which a reinforced fiber layer is separated from a resin layer, or a prepreg in which reinforced fiber is partially impregnated with resin. The composite material made of reinforced fiber and resin has physical properties such as high strength and stiffness, corrosion resistance, long fatigue life, wear resistance, and shock resistance, compared to other materials.

The sealing step of sealing the coupled end of the cover back 300 using the sealing tape 400, is a step of coupling and fully sealing the cover back 300 to surround the forming material 200 and of preparing a sealed space for being compressed in a vacuum state.

In the forming step of mutually compressing the reinforced fiber and the resin of the forming material 200 while the reinforced fiber is impregnated with the resin, the resin is completely infiltrated into pores in the reinforced fiber by the compressive force generated when the sealed space surrounded by the cover back 300 is compressed by introducing air into the nozzle connected to the cover back 300.

The method of using the cover back 300 and vacuum compressive force can more securely impregnate reinforced fiber with resin by removing bubbles in the reinforced fiber and replacing an empty space therein with the resin, compared to methods of stacking reinforced fiber in a portion to be sealed and infiltrating resin into the reinforced fiber.

When the cover back 300 is used in the embodiment, the forming material 200 is pressed by vacuum compressive force and negative pressure generated due to a difference between atmospheric pressure and inner pressure by sucking air into the cover back. Therefore, it is possible to remove bubble in the reinforced fiber and more securely impregnate the reinforced fiber with the resin.

In addition, since the forming material 200 made of reinforced fiber and resin is compressed in a uniform direction using the contact area with the cover back 300, the joint 100 can be sealed while having a smooth surface. Thus, it is possible to easily seal the joint 100 having a relatively complicated shape.

In the removal step of hardening the resin and removing the cover back 300 and the sealing tape 400, the sealing of the panel joint 100 is completed by completely hardening the resin in the reinforced fiber, attaching the reinforced fiber to the joint 100 and simultaneously sealing the joint 100, and removing the cover back 300 and the sealing tape 400.

The resin may generally be epoxy resin, polyester resin, thermoplastic resin, or the like.

According to the present invention, the method of sealing the panel joint 100 by the forming material made of reinforced fiber and resin is carried out in a vacuum compression manner using compressive force for securely bonding the panels.

The forming step of the method of sealing a panel joint is performed in high temperature in the state in which the forming material is inserted into an oven.

When the forming step is performed at high temperature in the state in which the composite material is inserted into the oven, rather than when the composite material goes through the forming step at room temperature using vacuum pressure, the resin has high fluidity and may be more densely infiltrated into the reinforced fiber. In addition, the forming step may be performed under a constant temperature at which the fluidity of the resin is active.

In the embodiment, since the forming step is performed under high temperature and high pressure using an autoclave, the sealing process may be performed in an optimal situation by regulating temperature and pressure.

The method of sealing a panel joint according to the embodiment of the present invention may be performed using the cover back 300, and the reinforced fiber may be a woven fabric including carbon fiber.

The reinforced fiber may generally be glass fiber, aramid fiber, carbon fiber, or the like. From among them, when the carbon fiber is used for the panel joint 100 of the vehicle as the reinforced fiber, fuel efficiency may be improved since the carbon fiber allows the vehicle to have high strength and a reduced weight due to characteristics of the carbon fiber material.

In addition, when the carbon fiber is used for the door part or tailgate of the vehicle, the stiffness thereof may be increased, and it is thus possible to prevent torsion from occurring due to the lack of stiffness.

The method of sealing a panel joint according to the embodiment of the present invention further includes a preparation step of providing an engraving 500 having a protruding shape around the panel joint 100, before the attachment step. In the attachment step, the forming material 200 is attached to the joint 100 so as to surround the joint 100 at a portion inside the engraving 500.

If the engraving 500 having a protruding shape is not provided around the joint 100, the resin in the reinforced fiber may flow before hardening in the sealing process. For this reason, the boundary of the panel joint 100 may be blurred and the panel joint may have a poor external appearance.

Accordingly, this problem may be resolved by providing the engraving 500 made of rubber or silicon in the boundary to be bonded and attaching the forming material 200 inward from the engraving 500 such that the resin does not flow out therefrom.

A panel joint 100 according to an embodiment of the present invention may be sealed through an attachment step of attaching a forming material 200 made of resin and reinforced fiber to the joint 100 as the bonded end of a plurality of panels such that the joint 100 is surrounded with the forming material 200, a sealing step of coupling a cover back 300 to surround the forming material 200, and of sealing the coupled end of the cover back 300 using a sealing tape 400, a forming step of mutually compressing the reinforced fiber and the resin of the forming material, while the reinforced fiber is impregnated with the resin, using the compressive force of the cover back 300 generated by introducing air into a nozzle connected to the cover back 300, and a removal step of hardening the resin and removing the cover back 300 and the sealing tape 400.

The panel joint 100 sealed by the method of sealing a panel joint is attached so as to be surrounded with the forming material 200 made of reinforced fiber and resin, and the resin fills the reinforced fiber and is then hardened, thereby allowing the clearance between the panel to be sealed.

Further, a panel joint may include: a forming material 200 made of resin and reinforced fiber attached to a joint 100 as a bonded end of a plurality of panels such that the joint 100 is surrounded with the forming material 200; and a cover back 300 coupled to the forming material 200 so as to surround the forming material 200, a coupled end of the cover back 300 being sealed using a sealing tape 400, the cover back 300 and the sealing tape 400 configured to be removed after the resin is hardened, where the reinforced fiber and the resin of the forming material are mutually compressed, while the reinforced fiber is impregnated with the resin, using compressive force of the cover back 300 generated by introducing air into a nozzle connected to the cover back 300.

Since the resin is more densely infiltrated into the reinforced fiber in the vacuum compression manner using the cover back 300 and the panel joint are securely attached, the panel joint 100 can be securely sealed compared to panel joints using other existing processes.

Consequently, it is possible to prevent water from leaking to the clearance between the panels, and physical properties such as high strength and stiffness, wear resistance, and corrosion resistance may be maintained as they are since the composite material made of reinforced fiber and resin is used for the panel joint.

The reinforced fiber of the panel joint 100 may be a woven fabric including carbon fiber.

As described above, since the carbon fiber preferably is used as the reinforced fiber, the carbon fiber allows the vehicle to have high strength and reduced weight due to characteristics of the carbon fiber material.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method of sealing a panel joint, comprising the steps of:
attaching a forming material made of resin and reinforced fiber to a joint as a bonded end of a plurality of panels such that the joint is surrounded with the forming material;
coupling a cover back to surround the forming material, and sealing a coupled end of the cover back using a sealing tape;
mutually compressing the reinforced fiber and the resin of the forming material, while the reinforced fiber is impregnated with the resin, using compressive force of the cover back generated by introducing air into a nozzle connected to the cover back; and
hardening the resin and removing the cover back and the sealing tape.

2. The method according to claim 1, wherein the step of mutually compressing the reinforced fiber and the resin of the forming material is performed at high temperature in a state in which the forming material is inserted into an oven.

3. The method according to claim 1, wherein the reinforced fiber is a woven fabric including carbon fiber.

4. The method according to claim 1, further comprising the step of: providing an engraving having a protruding shape around the panel joint, which is performed before the step of attaching the forming material made of the resin and the reinforced fiber to the joint,
wherein, in the step of attaching the forming material made of the resin and the reinforced fiber to the joint, the forming material is attached to the joint so as to surround the joint at a portion inside the engraving.

5. A panel joint, comprising:
a forming material made of resin and reinforced fiber attached to a joint as a bonded end of a plurality of panels such that the joint is surrounded with the forming material; and
a cover back coupled to the forming material so as to surround the forming material, a coupled end of the cover back being sealed using a sealing tape, the cover back and the sealing tape configured to be removed after the resin is hardened,
wherein the reinforced fiber and the resin of the forming material are mutually compressed, while the reinforced fiber is impregnated with the resin, using compressive force of the cover back generated by introducing air into a nozzle connected to the cover back.

6. The panel joint according to claim 5, wherein the forming material made of the reinforced fiber and the resin surrounds the bonded end of the panels, and the resin in the reinforced fiber is hardened, thereby allowing a clearance between the panels to be sealed.

7. The panel joint according to claim 5, wherein the reinforced fiber is a woven fabric including carbon fiber.
